(19) United States
(12) Patent Application Publication
(10) Pub. No.: US 2008/0121032 A1
(43) Pub. Date: May 29, 2008

(54) Stepless-adjustable tire pressure monitoring sensor housing assembly

(75) Inventors: Zhenfang Qiu, Shanghai (CN); Jiansong Huang, Shanghai (CN); Zhidong Chen, Shanghai (CN)

Correspondence Address: HAMRE, SCHUMANN, MUELLER & LARSON, P.C., P.O. BOX 2902, MINNEAPOLIS, MN, 55402-0902, US

(73) Assignee: SHANGHAI BAOLONG AUTOMOTIVE CORPORATION, Shanghai (CN)

(21) Appl. No.: 11/796,834

(22) Filed: Apr. 30, 2007

(30) Foreign Application Priority Data
Nov. 29, 2006 (CN) 200620048261.1

(51) Int. Cl. B60C 23/04

(52) U.S. Cl. 73/146.8

(57) ABSTRACT

The present invention discloses a stepless adjustable tire pressure monitoring sensor signal housing assembly, which consists of a sensor signal housing with a housing holder and a connecting part on the center of the holder. The connecting part has a curve connecting face where a Slot 1 is provided. It also includes a D block which has a flat part and a cylinder part. On the cylinder part, a Slot 2 is provided longitudinally. Two mounting holes are provided on the wall of the deep side of the Slot 2, two springs and two needle rollers are installed in the two holes respectively. A through hole is also provided in the center of the cylinder part perpendicular to the flat part. It still contains a connector which fixes the sensor signal housing and the D block onto the tire valve through the Slot 1 in the signal housing and the Slot 2 in the D block. The TPMS signal housing of the stepless adjustable tire pressure monitoring sensor signal housing assembly of the present invention is connected to the tire valve in a movable way, which is not only convenient for installation and debugging, but also applicable for rims of various sizes.

### TECHNOLOGICAL FIELD

The present invention involves a stepless adjustable tire pressure monitoring sensor (TPMS signal housing connecting assembly).

### EXISTING TECHNOLOGY

Inflation is required for all vehicle tires at present. As the tire pressure concerns the driving safety of vehicles, it is necessary to install electronic safety sensors on tires for real time monitoring of the tire pressure. Vehicle manufacturers in different countries have launched out monitoring devices consisting of an electronic sensor and a tire valve for installing on vehicle tires to monitor tire pressure. However, the tire valve has to be installed externally due to the special closed structure of tires, and a prior tire valve with an installed electronic signal housing (containing monitoring elements and batteries) is much larger than a traditional one, so it is difficult to install. In addition, there are various sizes of vehicle rims (rings), and an electronic signal housing containing electronic elements and batteries need to be fixed on the rim and locked on the rim hole firmly to withstand the centrifugal caused by tire rotation. However, if the signal housing on the tire valve is completely connected to the rim, the friction heat generated by the high speed rotating rim will be transferred to the electronic signal housing in the tire and influence the reliability of the electronic elements (heat dissipation is difficult). In addition, the centrifugal caused by the high speed rotating tire changes with the change of speed and road evenness, so the radial load applied on the tire valve changes unceasingly resulting in unsecured and loose installation. In addition, the rims are circular and their radius, arc size and shape differ from one another, so the electronic signal housing on the tire valve may not be connected properly to the rim, and one size of electronic signal housing cannot apply to multiple sizes of rims. Therefore, there are few of products which can be reliably, successfully and economically used for commercial purposes in China and abroad. The main reason is that the design structure is complicated and lack of commercial practicability. For example, for some products in which the electronic signal housing fixed on the rim by a steel strip, the steel strip is liable to loosing and falling off with vibration; for some products in which the electronic signal housing is bonded on the rim with glue, the electronic elements may be overheated and damaged because the humidity and temperature conditions are severe and the housing is connected to the rim (steel or aluminium), the heat generated by braking will be transferred to the housing to cause the electronic elements inside overheated, in addition, the adhesion of the glue will deteriorate after a long period of operation resulting in falling of; and for some products in which the tire valve is molded with the electronic signal housing, the housing and the tire valve cannot be rotated and adjusted, and with a same process precision, one size of signal housings is only applicable for 1 size of rims. There are also some products with adjustable electronic signal housing and tire valve, but it is hard to ensure the stability of the structure, and a long period of vibration will cause looseness.

### SUMMARY OF THE INVENTION

Aiming at the above problems, the present invention brought out a stepless adjustable tire pressure monitoring sensor signal housing assembly, which is a vehicle TPMS signal housing assembly with a stepless adjustable rotation angle (5°˜35°, applicable for different sizes of rims). The tire valve of the assembly can be a metal tire valve or a snap-in tire valve, the TPMS signal housing and the tire valve are connected in a movable way, which is not only convenient for installation and debugging, but also applicable for rims of various sizes.

To realize the above mentioned purposes, the present invention provides a stepless-adjustable tire pressure monitoring sensor signal housing assembly, including a tire valve and a valve inside fixed on a rim. It features a sensor signal housing including a housing holder and a connecting part in the center of the holder, the connecting part has a curve connecting face where a Slot 1 is provided; a D block, in D shape, which has a flat part and a cylinder part; on the cylinder part, a Slot 2 is provided longitudinally, two mounting holes are provided on the wall of the deep side of the Slot 2, two springs and two needle rollers are installed in the two holes respectively; a through hole is also provided in the center of the cylinder part perpendicular to the flat part; and a connector which fixes the sensor signal housing and the D block onto the tire valve through the Slot 1 in the signal housing and the Slot 2 in the D block.

The advantage is that the connecting face of the said sensor signal housing and the cylinder of the D block are concentric arcs.

The advantage is that the said Slot 1 is a long slot.

The present invention also provides another stepless adjustable tire pressure monitoring sensor signal housing assembly, including an tire valve and valve inside fixed on the rim, which features that a sensor signal housing including a housing holder and a connecting part on the center of the holder, the connecting part has a curve connecting face where a Slot 1 and a Slot 2 are provided; two mounting holes provided on the wall of the deep side of the Slot 2 with two springs and two needle rollers installed in the two holes respectively; a D block, in D shape, which has a flat part and a cylinder part; a through hole which is also provided in the center of the cylinder part perpendicular to the flat part; a connector which fixes the sensor signal housing and the D block on the tire valve through the Slot 1 in the signal housing and the Slot 2 in D block.

The advantage is that the connecting face of the said sensor signal housing and the cylinder of the D block are concentric arcs.

The advantage is that the said Slot 1 is a long slot.

The TPMS signal housing of the assembly of the present invention is connected to the tire valve in a movable way, which is not only convenient for installation and debugging, but also applicable for rims of various sizes.

### BRIEF DESCRIPTION OF THE DRAWINGS

For those familiar with this technical field, the above and other purposes, features and advantages of the present invention are apparent through the detailed description with reference to the figures.

FIG. 1 is a cross-section view of a preferable embodiment of the present invention;

FIG. 2 is a partial close-up view of FIG. 1;

FIG. 3 is a perspective diagram of the sensor signal housing 1 in FIG. 1;

FIG. 4 is a perspective diagram of the D block 2 in FIG. 1;

FIG. 5 is a installation drawing of the present invention;

FIG. 6 is a cross-section view of another preferable embodiment of the present invention;

FIG. 7 is a partial close-up view of FIG. 6.

### DETAIL DESCRIPTION OF THE INVENTION

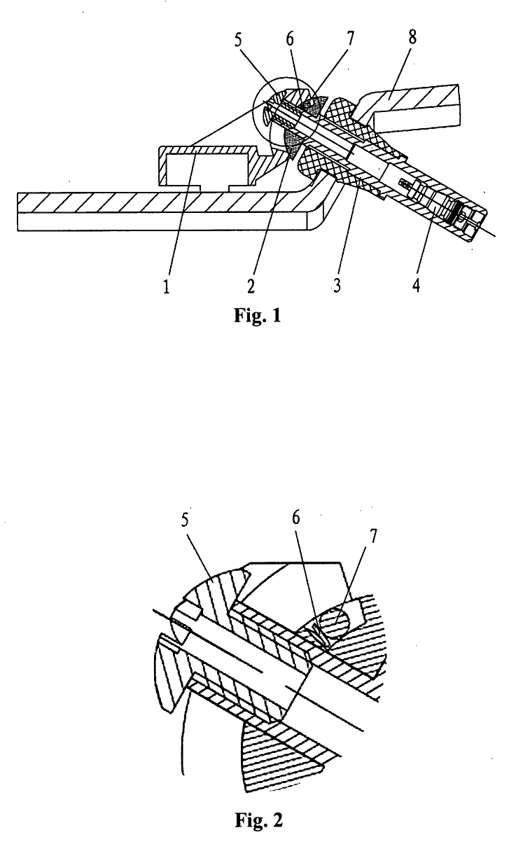

One preferable embodiment of the stepless adjustable tire pressure monitor sensor signal housing assemblies of the present invention is shown in FIG. 1, consisting of a sensor signal housing 1, a D block 2, a tire valve 3, a valve inside 4, a screw 5, a spring 6 and a needle roller 7. Among them, the D block 2, as shown in FIG. 4, is in D shape, consisting of a flat part 21 and a cylinder part 22. On the cylinder part 22, a long slot (i.e. a needle roller slot 23) is provided longitudinally. Two spring mounting holes 24 are provided on the wall of the deep side of the needle roller slot 23. A through hole 25 is also provided in the center of the cylinder part 22 of D block 2 perpendicular to the flat part 21.

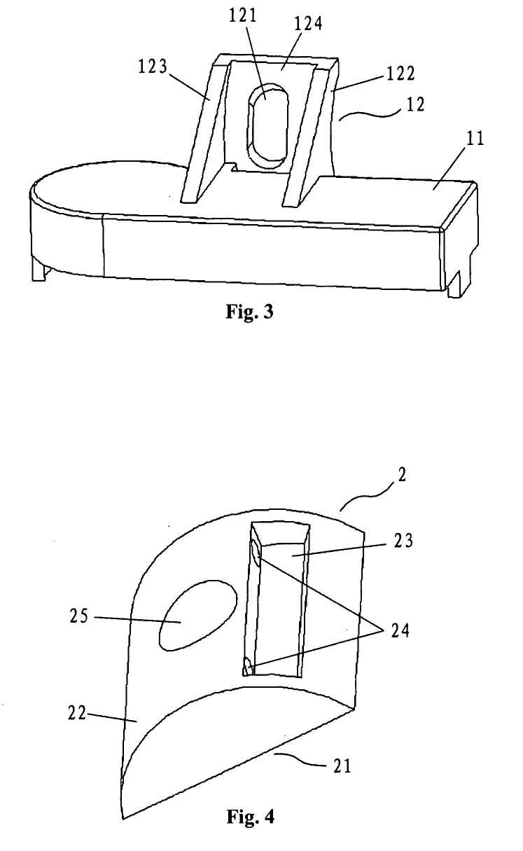

The structure of the signal housing 1 is shown in FIG. 3, including a housing holder 11 and a connecting part 12 on the center of the holder 11. The connecting part 12 consists of two symmetrical connectors 122 and 123 and a curve connecting face 124. A long slot 121 is provided in the connecting face 124.

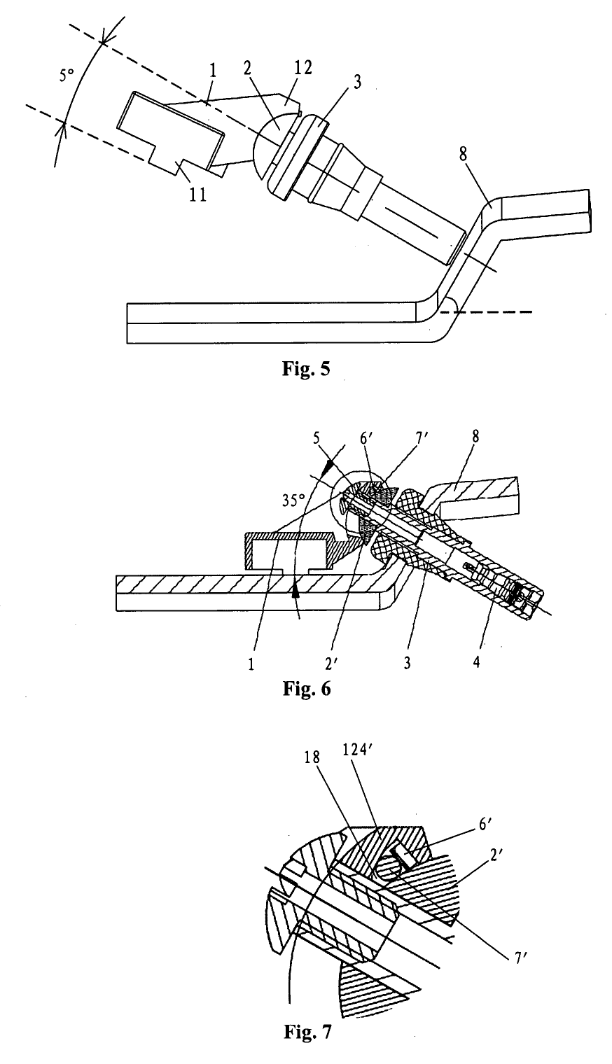

For installation, refer to the signal housing assembling procedure in FIG. 1-4. First, install the D block 2 onto the tire valve 3 through the mounting hole 25 with the flat part 21 abutting against the shoulder on the surface of the tire valve 3. Second, place a spring 6 in each of the holes 24 of the needle roller slot 23 and then place the needle roller 7 into the slot 23 in the D block 2 so that the spring 6 is inserted between the bottom of the slot 23 and the needle roller 7. Then fix the long slot 121 in the connecting face 124 of the sensor signal housing 1 to the valve inside 4. The curve connecting face 124 can match with the cylinder part 22 of the D block 2 perfectly without any clearance. Finally, put the screw 5 through the long slot 121 in the sensor signal housing 1 and the mounting hole 25 of D block 2, thus the signal housing 1 and the D block 2 are fixed on the valve inside 3. FIG. 5 shows an assembled signal housing.

According to the close-up view of FIG. 2, as the signal housing 1 is connected with the screw 5 through the long slot 121, the tire valve 3 can slide up and down in the long slot 121. The screw 5 and the D block 2 clamp the signal housing 1 in two directions so that it can only rotate around the D block 2 upward and downward. The depth of the needle roller slot 23 in the D block 2 (FIG. 4) changes with the cylinder 22. As the arcs of the D block 2 and the connecting face 124 are concentric, they fit with each other perfectly. When the signal housing 1 rotates clockwise around the D block 2, the needle roller 7 is pushed to the shallow part in the slot 23 by friction between the internal wall of the connecting face 124 and the needle roller 7 and the action of the spring 6, thus to fix it between the internal and the external arcs of the connecting face 124 and the cylinder 22, so the clockwise rotation of the signal housing 1 is restricted; when the signal housing 1 rotates counterclockwise around the circle center, the needle roller 7 is pushed to the deep part in the slot 23 by friction between the internal wall of the connecting face 124 and the needle roller 7 and the action of the compressed spring 6, thus to release the needle roller 7, so the signal housing 1 can rotate counterclockwise freely to realize the function of one way. When the needle roller 7 moves to the deep part in the slot 23, the sensor signal housing 1 can rotate around D block 2; when the needle roller 7 moves to the shallow part in the slot 23, the rotation of the sensor signal housing 1 around the D block 2 is restricted.

When it is required to readjust the position of the signal housing 1 in clockwise direction, push the needle roller 7 downward manually, then the sensor signal housing 1 can rotate upward around the D block 2 to any angle required.

With this mechanism, the signal housing 1 can only turn around D block 2 downward and be locked at a desired angle. In a similar way, this function can also be realized by changing the positions of the needle roller slot 23 and the needle roller 7 to the corresponding arc surface of the signal housing 1.

FIG. 5 shows a signal housing assembly installed on a rim 8. First, push the needle roller 7 downward manually so that the sensor signal housing 1 can turn upward around the D block 2. Turn the sensor signal housing 1 so that the angle between the bottom of the housing holder 11 and the center line of the tire valve 3 is 5°, then press the tire valve 3 of the assembly into the hole of the rim 8, and press the sensor signal housing 1 to turn it downward around the D block 2 and fix it on the rim 8 as shown in FIG. 1, thus the installation is completed. When a metal tire valve 3 is used, first push the needle roller 7 downward manually so that the sensor signal housing 1 can turn upward around the D block 2. Turn the sensor signal housing 1 so that the angle between the bottom of the housing holder 11 and the center line of the tire valve 3 is 5°, then install the assembled tire valve 3 of the assembly into the hole of the rim 8 normally, thereafter press sensor signal housing 1 to turn it downward around the D block 2 and fix it on the rim 8 as shown in FIG. 1, thus the installation is completed.

FIGS. 6 and 7 show the structure of another preferable embodiment of the present invention. The difference from that shown in FIG. 1 is that the needle roller slot 18 is in the connecting face 124′ of a signal housing 1′ in stead of in a D block 2′, and a needle roller 7′ and a spring 6′ are correspondingly changed to a connecting face 124′ from the D block 2′. The other structures are the same. The operating principle of this structure is similar to that shown in FIG. 1. As shown in FIG. 7, the depth of the needle roller slot 18 in the connecting face 124′ of the signal housing 1′ changes with the cylinder 22. As the arcs of the cylinder 22 of the D block 2 and the connecting face 124 are concentric, they fit perfectly. When the signal housing 1 rotates clockwise around the D block 2, the needle roller 7 is pushed to the shallow part in the slot 18 by friction between the cylinder 22 of the D block 2 and the needle roller 7 and the action of the spring 6, thus to fix it between the internal and the external arcs of the connecting face 124 and the cylinder 22, so the clockwise rotation of the signal housing 1 is restricted; when the signal housing 1 rotates counterclockwise around the circle center, the needle roller 7 is pushed to the deep part in slot 18 by friction between the cylinder 22 of the D block 2 and the needle roller 7 and the action of the compressed spring 6, thus to release the needle roller 7, so the signal housing 1 can rotate counterclockwise freely to realize the function of one way rotation. When the needle roller 7 moves to the deep part in the slot 18, the sensor signal housing 1 can rotate around D block 2; when the needle roller 7 moves to the shallow part in the slot 18, the rotation of the sensor signal housing 1 around the D block 2 is restricted.

When it is required to readjust the position of the signal housing 1 in clockwise direction, push the needle roller 7 upward manually, then the sensor signal housing 1 can rotate around the D block 2 to any angle required.

The above-mentioned embodiments are provided only for the description rather than the limitation of the present invention. Changes and medications can be made by those skilled in the relevant field with the spirit and within the range of the present invention. Therefore equivalent technological solutions are subject to the limitation of the Claims.

1. A stepless adjustable tire pressure monitoring sensor signal housing assembly, including a tire valve and a valve inside fixed on a rim, wherein the assembly contains:
a sensor signal housing, including a housing holder and a connecting part on the center of the said holder, the said holder has a curve connecting face where a Slot 1 is provided;
a D block, in D shape, including a flat part and a cylinder part, on the cylinder part, a Slot 2 is provided longitudinally, two mounting holes are provided on the wall of the deep side of the Slot 2, two springs and needle rollers are installed in the two holes respectively, a through hole is also provided in the center of the cylinder part perpendicular to the flat part; and
a connector which fixes the sensor signal housing and the D block onto the tire valve through the Slot 1 in the signal housing and the Slot 2 in the D block.

2. A stepless adjustable tire pressure monitoring sensor signal housing assembly according to claim 1, wherein:
the connecting face of the said sensor signal housing and the cylinder of the D block are concentric arcs.

3. A stepless adjustable tire pressure monitoring sensor signal housing assembly according to claim 1, wherein:
the said Slot 1 is a long slot.

4. A stepless adjustable tire pressure monitoring sensor signal housing assembly, including a tire valve and a valve inside fixed on a rim, wherein the assembly contains:
a sensor signal housing, including a housing holder and connecting part on the center of the said holder, the said holder has a curve connecting face where a Slot 1 and a Slot 2 are provided, on the wall of the Slot 2, two mounting holes are provided, two springs and needle rollers are installed in the two holes respectively;
a D block, in D shape, consisting of a flat part and a cylinder part, a through hole is also provided in the center of the cylinder part perpendicular to the flat part; and
a connector which fixes the sensor signal housing and the D block on the tire valve through the Slot 1 in the signal housing and the Slot 2 in the D block.

5. A stepless adjustable tire pressure monitoring sensor signal housing assembly according to claim 4, wherein:
the connecting face of the said sensor signal housing and the cylinder of the D block are concentric arcs.

6. A stepless adjustable tire pressure monitoring sensor signal housing assembly according to claim 5, wherein:
the said Slot 1 is a long slot.
